(19) United States
(12) Patent Application Publication
(10) Pub. No.: US 2006/0092116 A1
(43) Pub. Date: May 4, 2006

(54) Liquid crystal display

(75) Inventors: Yoon-Sung Um, Yongin-si (KR); Jae-Jin Lyu, Gwangju-gun (KR); Woo-Shik Lee, Seoul (KR); Tae-Seok Jang, Seoul (KR); Jeong-Seon Kim, Suwon-si (KR); Valery Krasnoslobodtsev, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd., Suwon-si (KR)

(21) Appl. No.: 11/259,788

(22) Filed: Oct. 27, 2005

(30) Foreign Application Priority Data
Oct. 29, 2004 (KR) 10-2004-0087232

(51) Int. Cl. G09G 3/36

(52) U.S. Cl. 345/92

(57) ABSTRACT

A liquid crystal display is provided, which includes: a first signal line; a second signal line intersecting the first signal line; a thin film transistor connected to the first and the second signal lines; a first field generating electrode and a second field generating electrode facing each other; and a liquid crystal layer disposed between the first electrode and the second electrode, wherein one of the first and the second field generating electrodes is connected to the thin film transistor, and the first field generating electrode includes a plurality of first branch electrodes extending obliquely to the first and the second signal lines.

### CROSS-REFERENCE TO RELATED APPLICATION

This application claims priority to Korean Patent Application No. 10-2004-0087232, filed on Oct. 29, 2004, the disclosure of which is incorporated herein by reference in its entirety.

### BACKGROUND OF THE INVENTION

1. Field of the Invention

The present invention relates to a liquid crystal display.

2. Description of Related Art

A liquid crystal display (LCD) is one of the most widely used flat panel displays. An LCD includes two panels provided with pixel electrodes and a common electrode (commonly referred to as “field generating electrodes”) and having a liquid crystal (LC) layer interposed therebetween. The LCD displays images by applying voltages to the field-generating electrodes to generate an electric field in the LC layer, which determines orientations of LC molecules in the LC layer to adjust polarization of incident light.

The LCD further includes a plurality of switching elements connected to the pixel electrodes and a plurality of signal lines such as gate lines and data lines for controlling the switching elements to apply voltages to the pixel electrodes.

Among the LCDs, a vertical alignment (VA) mode LCD, which aligns LC molecules such that the long axes of the LC molecules are perpendicular to the panels in the absence of an electric field, is more popular because of its high contrast ratio and wide reference viewing angle.

The wide viewing angle of the VA mode LCD can be realized by cutouts in the field-generating electrodes and protrusions on the field-generating electrodes. Since the cutouts and the protrusions can determine the tilt directions of the LC molecules, the tilt directions can be distributed into several directions by appropriately arranging the cutouts and the protrusions such that the reference viewing angle is widened.

However, the VA mode LCD has poor lateral visibility as compared with frontal visibility. For example, the LCD shows an image that becomes bright as it goes far from the front, and in the worse case, the luminance difference between the high grays vanishes such that the images cannot be perceived.

A pixel can be divided into two sub-pixels for improving the lateral visibility, and the sub-pixels can have different voltages. However, such a division may decrease the aperture ratio.

### SUMMARY OF THE INVENTION

A liquid crystal display is provided, which includes: a first signal line; a second signal line intersecting the first signal line; a thin film transistor connected to the first and the second signal lines; a first field generating electrode and a second field generating electrode facing each other; and a liquid crystal layer disposed between the first field generating electrode and the second field generating electrode, wherein one of the first and the second field generating electrodes is connected to the thin film transistor, and the first field generating electrode includes a plurality of first branch electrodes extending obliquely to the first and the second signal lines.

The first branch electrodes may be connected to each other.

According to an embodiment of the present invention, the first field generating electrode may further include a frame electrode connected to the first branch electrodes, and the frame electrode may have main edges substantially parallel to the first and the second signal lines. The first field generating electrode may be connected to the thin film transistor.

The first field generating electrode may further include a main body having an opening and the first branch electrodes cross the opening, and the opening may have edges substantially parallel to the first and the second signal lines. The second field generating electrode may be connected to the thin film transistor.

The first branch electrodes may have a width about 0.2-4 times the thickness of the liquid crystal layer.

A distance between the first branch electrodes may be about 1-10 times the thickness of the liquid crystal layer.

The liquid crystal display may further include a plurality of tilt direction determining members arranged alternatively to the first branch electrodes.

The tilt direction determining members may include a plurality of cutouts disposed at the second field generating electrode. The distance between the first branch electrode and the tilt direction determining member may be about 0.5-5 times the thickness of the liquid crystal layer.

The second field generating electrode may include a plurality of second branch electrodes arranged alternatively to the first branch electrodes.

The liquid crystal display may further include a third signal line overlapping the first branch electrodes.

The first field generating electrode may include a portion overlapping the first signal lines or the second signal line.

The first branch electrodes may include IZO (indium zinc oxide) or ITO (indium tin oxide) or the same layer as the first signal line or the second signal line.

### BRIEF DESCRIPTION OF THE DRAWINGS

The present invention will become more apparent by describing embodiments thereof in detail with reference to the accompanying drawings in which:

FIG. 1 shows a layout view of a TFT array panel for an LCD according to an embodiment of the present invention;

FIG. 2 shows a layout view of a common electrode panel for an LCD according to an embodiment of the present invention;

FIG. 3 shows a layout view of an LCD including the TFT array panel shown in FIG. 1 and the common electrode panel shown in FIG. 2;

FIG. 4 shows a sectional view of the LCD shown in FIG. 3 taken along line IV-IV′;

FIG. 5 shows a layout view of an LCD according to another embodiment of the present invention;

FIG. 6 shows a sectional view of the LCD shown in FIG. 5 taken along line VI-VI;

FIG. 7 shows a layout view of an LCD according to another embodiment of the present invention; and

FIG. 8 shows a sectional view of the LCD shown in FIG. 7 taken along line VIII-VIII.

### DETAILED DESCRIPTION OF EMBODIMENTS

The present invention now will be described more fully with reference to the accompanying drawings, in which preferred embodiments of the invention are shown. This invention may, however, be embodied in many different forms and should not be construed as limited to the embodiments set forth herein. Like numerals refer to like elements throughout.

In the drawings, the thickness of layers and regions are exaggerated for clarity. It will be understood that when an element such as a layer, region or substrate is referred to as being “on” another element, it can be directly on the other element or intervening elements may also be present. In contrast, when an element is referred to as being “directly on” another element, there are no intervening elements present.

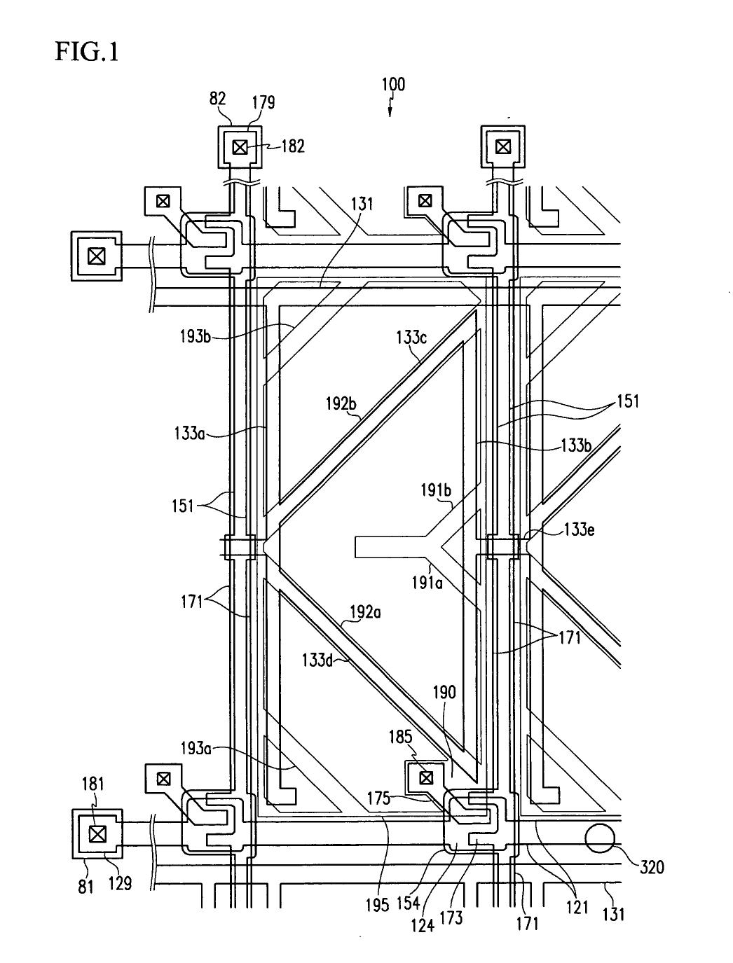

An LCD according to an embodiment of the present invention will be described in detail with reference to FIGS. 1, 2, 3 and 4.

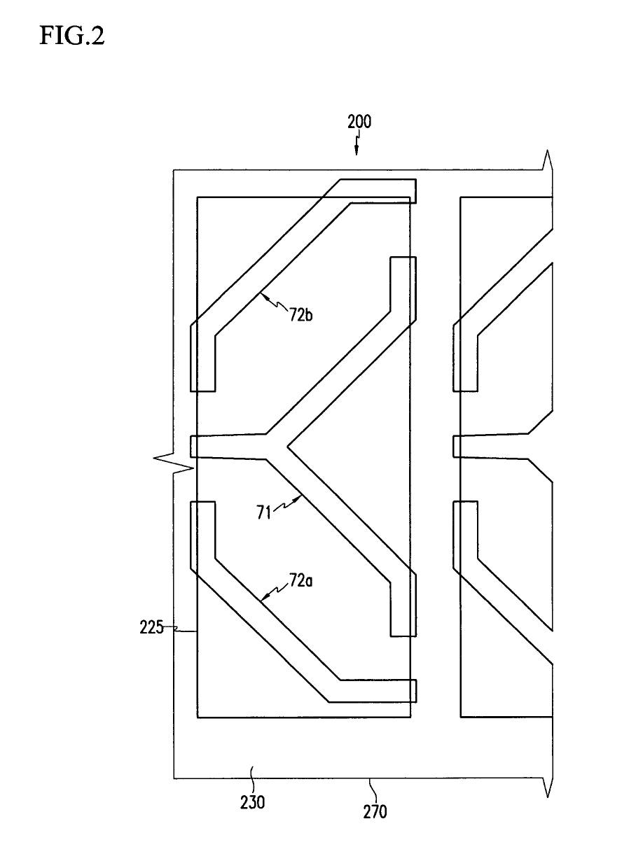

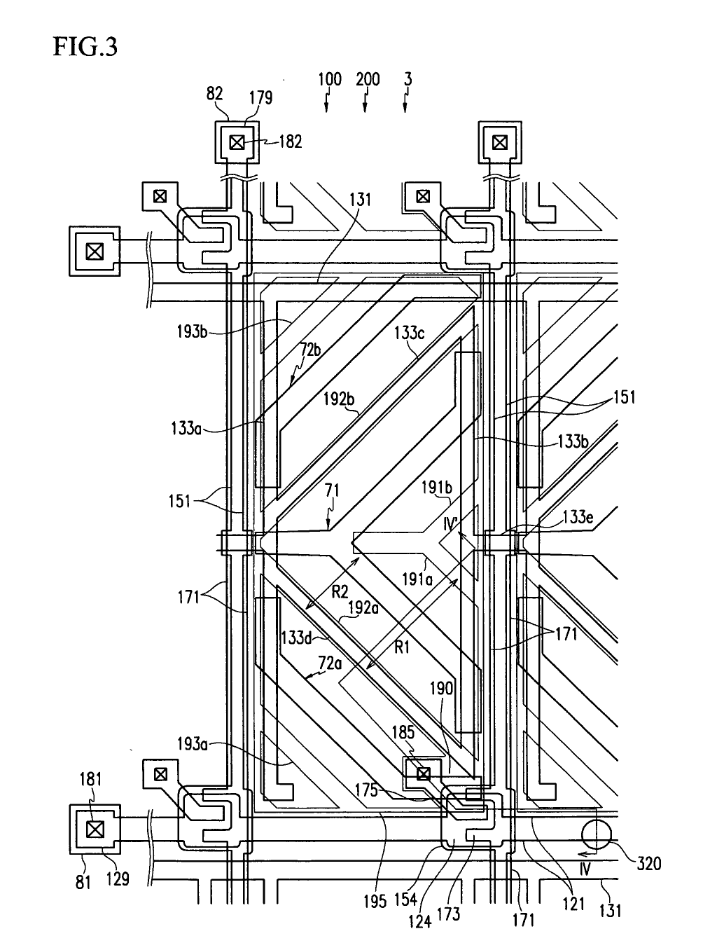

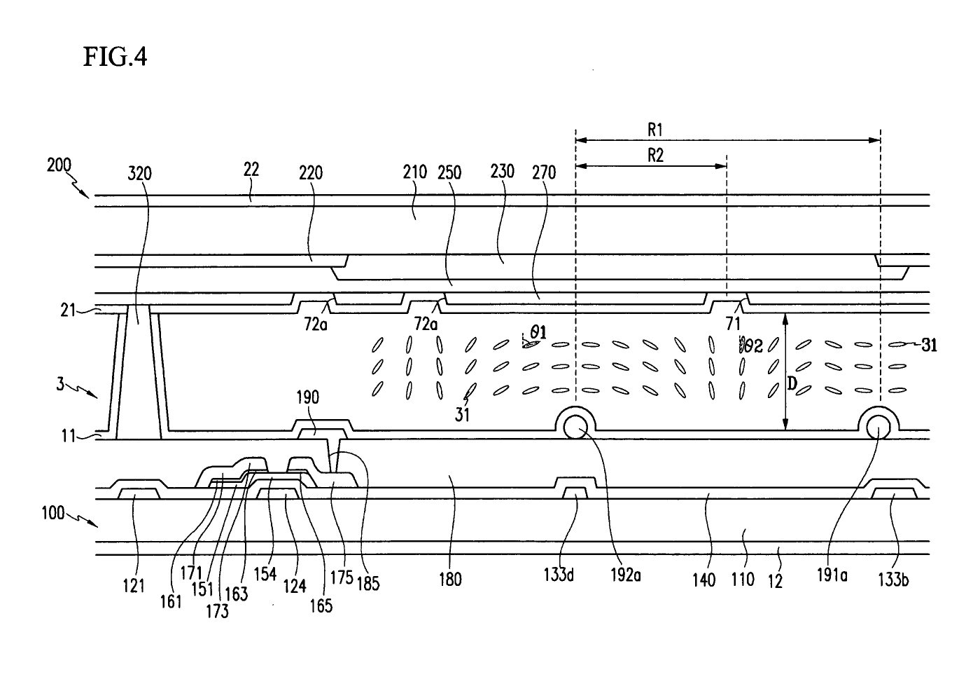

FIG. 1 shows a layout view of a TFT array panel for an LCD according to an embodiment of the present invention, FIG. 2 shows a layout view of a common electrode panel for an LCD according to an embodiment of the present invention, FIG. 3 shows a layout view of an LCD including the TFT array panel shown in FIG. 1 and the common electrode panel shown in FIG. 2, and FIG. 4 shows a sectional view of the LCD shown in FIG. 3 taken along line IV-IV′.

Referring to FIGS. 1-4, an LCD according to an embodiment of the present invention includes a TFT array panel 100, a common electrode panel 200 facing the TFT array panel 100, and a liquid crystal layer 3 interposed between the panels 100 and 200.

First, the TFT array panel 100 will be described with reference to FIGS. 1, 3 and 4.

A plurality of gate lines 121 and a plurality of storage electrode lines 131 are formed on an insulating substrate 110 such as transparent glass or plastic.

The gate lines 121 transmit gate signals and extend substantially in a transverse direction. Each of the gate lines 121 includes a plurality of gate electrodes 124 projecting from the gate lines 121 and a gate line end portion 129 having a large area for contact with another layer or an external drive circuit. A gate drive circuit (not shown) for generating the gate signals may be mounted on a flexible printed circuit (FPC) film (not shown), which may be attached to the insulating substrate 110, directly mounted on the insulating substrate 110, or integrated onto the insulating substrate 110. The gate lines 121 may extend to be connected to a drive circuit that may be integrated on the insulating substrate 110.

Each of the storage electrode lines 131 includes a stem extending substantially parallel to the gate lines 121, a plurality of sets of first, second, third and fourth storage electrodes 133a, 133b, 133c and 133d branched from the stem, and a plurality of storage connections 133e. Each of the storage electrode lines 131 is disposed between two adjacent gate lines 121 and the stem is close to an upper one of the two adjacent gate lines 121. The storage electrodes 133a-d are supplied with a predetermined voltage.

The first and the second storage electrodes 133a and 133b extend in a longitudinal direction and face each other. The first storage electrode 133a has a fixed end portion connected to the stem and a free end portion disposed opposite the fixed end portion and having a projection. The third and the four storage electrodes 133c and 133d obliquely extend approximately from a center of the first storage electrode 133a and upper and lower ends of the second storage electrode 133b, respectively. Each of the storage connections 133e is connected between adjacent sets of storage electrodes 133a-133d. However, the storage electrode lines 131 may have various shapes and arrangements.

The gate lines 121 and the storage electrode lines 131 are preferably made of Al containing metal such as Al and Al alloy, Ag containing metal such as Ag and Ag alloy, Cu containing metal such as Cu and Cu alloy, Mo containing metal such as Mo and Mo alloy, Cr, Ta, or Ti. However, they may have a multi-layered structure including two conductive films (not shown) having different physical characteristics. One of the two films is preferably made of low resistivity metal including Al containing metal, Ag containing metal, and Cu containing metal for reducing signal delay or voltage drop. The other film is preferably made of material such as Mo containing metal, Cr, Ta, or Ti, which has good physical, chemical, and electrical contact characteristics with other materials such as indium tin oxide (ITO) or indium zinc oxide (IZO). Good examples of the combination of the two films are a lower Cr film and an upper Al (alloy) film and a lower Al (alloy) film and an upper Mo (alloy) film. However, the gate lines 121 and the storage electrode lines 131 may be made of various metals or conductors.

Lateral sides of the gate lines 121 and the storage electrode lines 131 are inclined relative to a surface of the insulating substrate 110, and the inclination angle thereof ranges about 30-80 degrees.

A gate insulating layer 140 preferably made of silicon nitride (SiNx) or silicon oxide (SiOx) is formed on the gate lines 121 and the storage electrode lines 131.

A plurality of semiconductor stripes 151 preferably made of hydrogenated amorphous silicon (abbreviated to “a-Si”) or polysilicon are formed on the gate insulating layer 140. The semiconductor stripes 151 extend substantially in the longitudinal direction and become wide near the gate lines 121 and the storage electrode lines 131 such that the semiconductor stripes 151 cover large areas of the gate lines 121 and the storage electrode lines 131. Each of the semiconductor stripes 151 includes a plurality of semiconductor stripe projections 154 branched out toward the gate electrodes 124.

A plurality of ohmic contact stripes and ohmic contact islands 161 and 165 are formed on the semiconductor stripes 151. The ohmic contact stripes and ohmic contact islands 161 and 165 are preferably made of n+ hydrogenated a-Si heavily doped with n type impurity such as phosphorous or they may be made of silicide. Each ohmic contact stripe 161 includes a plurality of ohmic contact stripe projections 163, and the ohmic contact stripe projections 163 and the ohmic contact islands 165 are located in pairs on the semiconductor stripe projections 154.

Lateral sides of the semiconductor stripes 151 and the ohmic contacts 161 and 165 are inclined relative to the surface of the insulating substrate 110, and the inclination angles thereof are preferably in a range of about 30-80 degrees.

A plurality of data lines 171 and a plurality of drain electrodes 175 are formed on the ohmic contacts 161 and 165 and the gate insulating layer 140.

The data lines 171 transmit data signals and extend substantially in the longitudinal direction to intersect the gate lines 121, the stems of the storage electrode lines 131 and the storage connections 133e. Each data line 171 includes a plurality of source electrodes 173 projecting toward the gate electrodes 124 and curved like a character “C” and a data line end portion 179 having a large area for contact with another layer or an external drive circuit. A data drive circuit (not shown) for generating the data signals may be mounted on a FPC film (not shown), which may be attached to the insulating substrate 110, directly mounted on the insulating substrate 110, or integrated onto the insulating substrate 110. The data lines 171 may extend to be connected to a drive circuit that may be integrated on the insulating substrate 110.

The drain electrodes 175 are separated from the data lines 171 and disposed opposite the source electrodes 173 with respect to the gate electrodes 124.

Each drain electrode 175 includes a wide end portion and a narrow end portion. The narrow end portion is partly enclosed by a source electrode 173.

A gate electrode 124, a source electrode 173, and a drain electrode 175 along with a semiconductor stripe projection 154 form a TFT having a channel formed in the semiconductor stripe projection 154 disposed between the source electrode 173 and the drain electrode 175.

The data lines 171 and the drain electrodes 175 are preferably made of refractory metal such as Cr, Mo, Ta, Ti, or alloys thereof. However, they may have a multilayered structure including a refractory metal film (not shown) and a low resistivity film (not shown). Good examples of the multi-layered structure are a double-layered structure including a lower Cr/Mo (alloy) film and an upper Al (alloy) film and a triple-layered structure of a lower Mo (alloy) film, an intermediate Al (alloy) film, and an upper Mo (alloy) film. However, the data lines 171 and the drain electrodes 175 may be made of various metals or conductors.

The data lines 171 and the drain electrodes 175 have inclined edge profiles, and the inclination angles thereof range about 30-80 degrees.

The ohmic contacts 161 and 165 are interposed only between the underlying semiconductor stripes 151 and the overlying data lines 171 and drain electrodes 175 thereon and reduce the contact resistance therebetween. Although the semiconductor stripes 151 are narrower than the data lines 171 at most places, the width of the semiconductor stripes 151 becomes large near the gate lines 121 and the storage electrode lines 131 as described above, to smooth the profile of the surface, thereby preventing the disconnection of the data lines 171. The semiconductor stripes 151 include some exposed portions, which are not covered with the data lines 171 and the drain electrodes 175, such as portions located between the source electrodes 173 and the drain electrodes 175.

A passivation layer 180 is formed on the data lines 171, the drain electrodes 175, and the exposed portions of the semiconductor stripes 151. The passivation layer 180 is preferably made of inorganic or organic insulator and may have a flat top surface. Examples of the inorganic insulator include silicon nitride and silicon oxide. The organic insulator may have photosensitivity and dielectric constants less than about 4.0. The passivation layer 180 may include a lower film of inorganic insulator and an upper film of organic insulator such that it takes the excellent insulating characteristics of the organic insulator while preventing the exposed portions of the semiconductor stripes 151 from being damaged by the organic insulator.

The passivation layer 180 has a plurality of contact holes 181, 182 and 185 exposing the data line end portions 179 and the drain electrodes 175, respectively. The passivation layer 180 and the gate insulating layer 140 have a plurality of contact holes 181 exposing the gate line end portions 129.

A plurality of pixel electrodes 190 and a plurality of contact assistants 81 and 82 are formed on the passivation layer 180. They are preferably made of a transparent conductor such as ITO or IZO or a reflective conductor such as Ag, Al, Cr, or alloys thereof.

The pixel electrodes 190 are physically and electrically connected to the drain electrodes 175 through the contact holes 185 such that the pixel electrodes 190 receive data voltages from the drain electrodes 175. The pixel electrodes 190 supplied with the data voltages generate electric fields in cooperation with a common electrode 270 of the common electrode panel 200 supplied with a common voltage, which determine the orientations of liquid crystal molecules 31 of the liquid crystal layer 3 disposed between the two electrodes 190 and 270. A pixel electrode 190 and the common electrode 270 form a capacitor referred to as a “liquid crystal capacitor,” which stores applied voltages after the TFT turns off.

A pixel electrode 190 overlaps a storage electrode line 131 including storage electrodes 133a-133d. The pixel electrode 190 and a drain electrode 175 connected thereto and the storage electrode line 131 form an additional capacitor referred to as a “storage capacitor,” which enhances the voltage storing capacity of the liquid crystal capacitor.

Each pixel electrode 190 includes three lower branch electrodes 191a-193a, three upper branch electrodes 191b-193b, and a frame electrode 195 connected to the lower and the upper branch electrodes 191a-193b. The lower and upper branch electrodes 191a-193b substantially have an inversion symmetry with respect to an imaginary transverse line bisecting the frame electrode 195.

The lower and upper branch electrodes 191a-193b obliquely extend from right, lower, and upper edges of the frame electrode 195 approximately to the imaginary transverse line and a left edge of the frame electrode 195. The lower and upper branch electrodes 191a and 191b meet each other to form a transverse bar, and the lower and upper branch electrodes 192a and 192b overlap the third and fourth storage electrodes 133c and 133d, respectively. The lower and upper branch electrodes 191a-193a and 191b-193b form lower and upper halves of the pixel electrode 190, respectively, which can be divided by the imaginary transverse line. The lower and upper branch electrodes 192a and 192b make an angle of about 45 degrees to the gate lines 121, and extend substantially perpendicularly to each other.

Accordingly, the lower half of the pixel electrode 190 includes the lower branch electrodes 191a, 192a and 193a and the upper half of the pixel electrode 190 includes the upper branch electrodes 191b, 192b and 193b. The number of the branch electrodes is varied depending on the design factors such as the size of the pixels, the ratio of the transverse edges and the longitudinal edges of the pixel electrode 190, and the type and characteristics of the liquid crystal layer 3.

The contact assistants 81 and 82 are connected to the gate line end portions 129 and the data line end portions 179 through the contact holes 181 and 182, respectively. The contact assistants 81 and 82 protect the gate line end portions 129 and the data line end portions 179 and enhance the adhesion between the gate line end portions 129 and the data line end portions 179 and external devices.

The description of the common electrode panel 200 follows with reference to FIGS. 2-4.

A light blocking member 220 referred to as a black matrix for preventing light leakage is formed on an insulating substrate 210 such as transparent glass or plastic. The light blocking member 220 has a plurality of light blocking member openings 225 that face the pixel electrodes 190 and may have substantially the same planar shape as the pixel electrodes 190. Otherwise, the light blocking member 220 may include a plurality of rectilinear portions facing the data lines 171 on the TFT array panel 100 and a plurality of widened portions facing the TFTs on the TFT array panel 100.

A plurality of color filters 230 are also formed on the insulating substrate 210 and are disposed substantially in the areas enclosed by the light blocking member 220. The color filters 230 may extend substantially in the longitudinal direction along the pixel electrodes 190. The color filters 230 may represent one of the primary colors such as red, green and blue colors.

An overcoat 250 is formed on the color filters 230 and the light blocking member 220. The overcoat 250 is preferably made of an organic insulator and it prevents the color filters 230 from being exposed and provides a flat surface. The overcoat 250 may be omitted.

A common electrode 270 is formed on the overcoat 250. The common electrode 270 is preferably made of transparent conductive material such as ITO and IZO and has a plurality of sets of cutouts 71, 72a and 72b.

A set of cutouts 71-72b face a pixel electrode 190 including a frame electrode 195 and lower and upper branch electrodes 191a-193b and the set of cutouts 71-72b include a center cutout 71, a lower cutout 72a, and an upper cutout 72b. Each of the cutouts 71-72b is disposed between adjacent branch electrodes 191a-193b of the pixel electrode 190. Each of the cutouts 71-72b has at least an oblique portion extending substantially parallel to the lower branch electrodes 191a-193a or the upper branch electrodes 191b-193b of the pixel electrode 190. The cutouts 71-72b have substantially an inversion symmetry with respect to the above-described imaginary transverse line bisecting the pixel electrode 190.

Each of the lower and upper cutouts 72a and 72b includes an oblique portion, a transverse portion, and a longitudinal portion. The oblique portion extends approximately from a left edge of the frame electrode 195 approximately to a lower or an upper edge of the frame electrode 195. Each of the transverse and the longitudinal portions extends from a respective end of the oblique portion along an edge of the frame electrode 195, overlapping the edge of the frame electrode 195, and making an obtuse angle with the oblique portion.

The center cutout 71 includes a central transverse portion, a pair of oblique portions, and a pair of terminal longitudinal portions. The central transverse portion extends approximately from the left edge of the frame electrode 195 along the above-described transverse line. The oblique portions extend from an end of the central transverse portion approximately to the right edge of the frame electrode 195 and make oblique angles with the central transverse portion. The terminal longitudinal portions extend from the ends of the respective oblique portions along the right edge of the frame electrode 195, overlapping the right edge of the frame electrode 195, and making obtuse angles with the respective oblique portions.

The number of the cutouts 71-72b may be varied depending on the design factors, and the light blocking member 220 may also overlap the cutouts 71-72b to block the light leakage through the cutouts 71-72b.

A plurality of columnar spacers 320 are formed on the TFT array panel 100. The spacers 320 are preferably made of insulating material and props the TFT array panel 100 and the common electrode panel 200 to form a cell gap D therebetween to be filled with the LC layer 3.

Alignment layers 11 and 21 that may be homeotropic are coated on the inner surfaces of the panels 100 and 200, and polarizers 12 and 22 are provided on the outer surfaces of the panels 100 and 200 so that their polarization axes may be crossed and one of the polarization axes may be parallel to the gate lines 121. One of the polarizers 12 and 22 may be omitted when the LCD is a reflective LCD.

The LCD may further include at least one retardation film (not shown) for compensating the retardation of the LC layer 3. The LCD may further include a backlight unit (not shown) supplying light to the LC layer 3 through the polarizers 12 and 22, the retardation film, and the panels 100 and 200.

It is preferable that the LC layer 3 has a negative dielectric anisotropy and is subjected to a vertical alignment and that the LC molecules 31 in the LC layer 3 are aligned such that their long axes are substantially vertical to the surfaces of the panels 100 and 200 in the absence of an electric field. Accordingly, incident light cannot pass the crossed polarization system 12 and 22.

Upon application of the common voltage to the common electrode 270 and a data voltage to a pixel electrode 190, an electric field substantially perpendicular to the surfaces of the panels 100 and 200 is generated. The LC molecules 31 tend to change their orientations in response to the electric field such that their long axes are perpendicular to the field direction.

The branch electrodes 191a-193b and the cutouts 71-72b of the common electrode 270 distort the electric field to have a horizontal component that is substantially perpendicular to the edges of the branch electrodes 191a-193b and 71-72b.

Referring to FIG. 3, a set of the branch electrodes 191a-191b and the cutouts 71-72b define a plurality of sub-areas, and each sub-area has two primary edges making oblique angles with the major edges of the frame electrode 195. Since most LC molecules 31 on each sub-area tilt perpendicular to the primary edges, the azimuthal distribution of the tilt directions are localized to four directions, thereby increasing the reference viewing angle of the LCD.

The width or the diameter of the branch electrodes 191a-193b is preferably about 0.2 to about 4 times the cell gap D, the distance R1 between the branch electrodes 191a-193b is preferably about 1-10 times the cell gap D, and the distance R2 between the branch electrodes 191a-193b and the cutouts 71-72b is preferably about 0.5 to about 5 times the cell gap D and equal to about a half of the distance R1 between the branch electrodes 191a-193b.

The strength of the electric field in the LC layer 3 continuously decreases farther from the branch electrodes 191a-193b. Since the tilt angle of the LC molecules 31 depends on the strength of the electric field, the LC molecules 31 near the branch electrodes 191a-193b have a large tilt angle θ1 relative to those far from the branch electrodes 191a-193b that have a small tilt angle θ2. The LC molecules 31 that are disposed equidistant from adjacent branch electrodes 191a-193b, i.e., those on a vertical plane passing through the cutouts 71-72b have the largest tilt angle.

Accordingly, the tilt angle of the LC molecules 31 on each sub-area continuously varies such that a region (referred to as a domain) of the LC layer 3 disposed on each sub-area has an infinite number of sub-domains having different tilt angles. The optical properties of the sub-domains compensate for each other to improve the lateral visibility.

The shapes and the arrangements of the branch electrodes 191a-191b and the cutouts 71-72b may be modified.

At least one of the cutouts 71-72b can be substituted with protrusions (not shown) or depressions (not shown). The protrusions are preferably made of organic or inorganic material and are disposed on or under the pixel electrodes 190 or the common electrode 270.

The pixel electrodes 190 may be formed on the same layer as the gate lines 121 or the data lines 171.

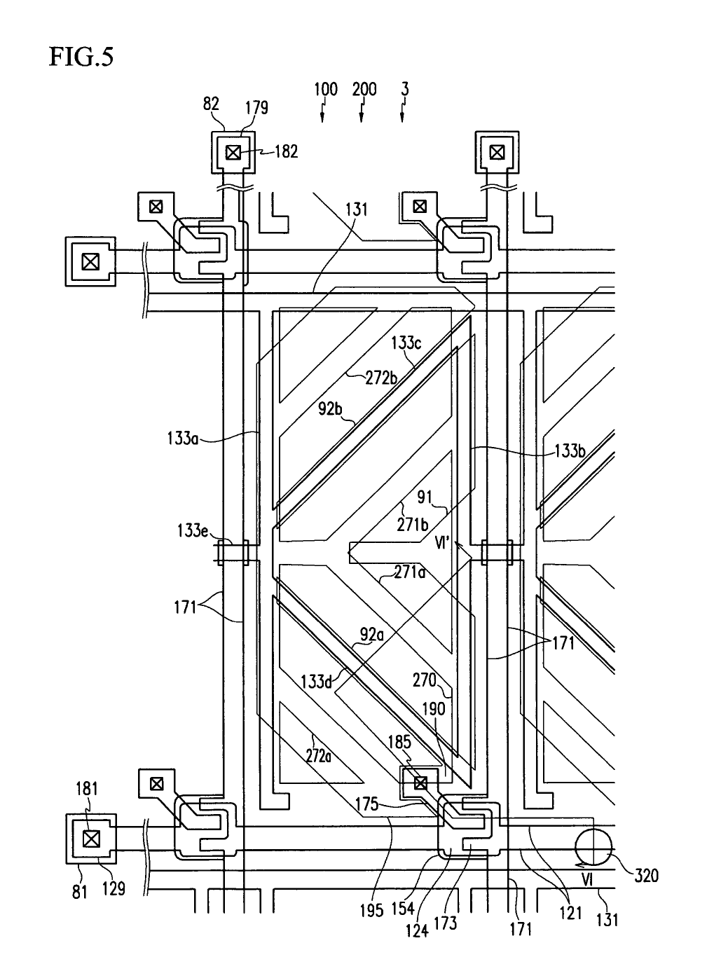

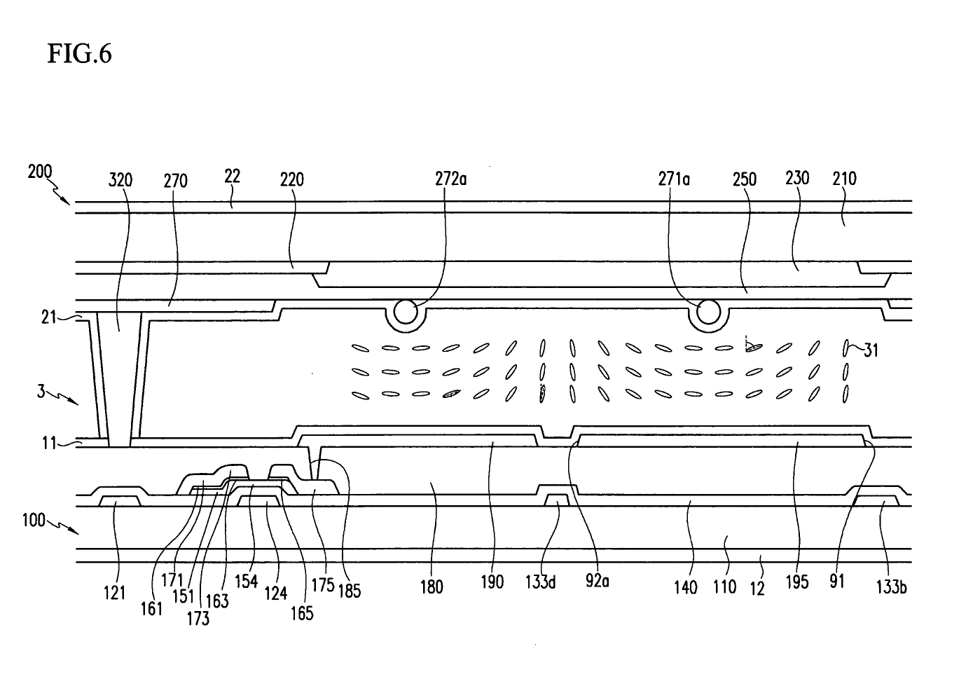

An LCD according to another embodiment of the present invention will be described in detail with reference to FIGS. 5 and 6.

FIG. 5 shows a layout view of an LCD according to another embodiment of the present invention, and FIG. 6 shows a sectional view of the LCD shown in FIG. 5 taken along the line VI-VI′.

Referring to FIGS. 5 and 6, an LCD according to this embodiment includes a TFT array panel 100, a common electrode panel 200, a LC layer 3 and a plurality of columnar spacers 320 interposed between the panels 100 and 200, and a pair of polarizers 12 and 22 attached on outer surfaces of the panels 100 and 200.

Layered structures of the panels 100 and 200 according to this embodiment are almost the same as those shown in FIGS. 1-4.

Regarding the TFT array panel 100, a plurality of gate lines 121 including gate electrodes 124 and gate line end portions 129 and a plurality of storage electrode lines 131 including storage electrodes 133a-133d and storage connections 133e are formed on an insulating substrate 110. A gate insulating layer 140, a plurality of semiconductor stripes 151 including semiconductor stripe projections 154, and a plurality of ohmic contact stripes 161 including ohmic contact stripe projections 163 and a plurality of ohmic contact islands 165 are sequentially formed on the gate lines 121 and the storage electrode lines 131. A plurality of data lines 171 including source electrodes 173 and data line end portions 179 and a plurality of drain electrodes 175 are formed on the ohmic contacts 161 and 165, and a passivation layer 180 is formed thereon. A plurality of contact holes 181, 182 and 185 are provided at the passivation layer 180 and the gate insulating layer 140. A plurality of pixel electrodes 190 and a plurality of contact assistants 81 and 82 are formed on the passivation layer 180, and a plurality of columnar spacers 320 and an alignment layer 11 are formed thereon.

Regarding the common electrode panel 200, a light blocking member 220, a plurality of color filters 230, an overcoat 250, a common electrode 270, and an alignment layer 21 are formed on an insulating substrate 210.

Different from the LCD shown in FIGS. 1-4, the common electrode 270 includes a plurality of sets of branch electrodes 271a, 271b, 272a and 272b instead of the cutouts 71-72b, while each of the pixel electrodes 190 has a plurality of cutouts 91-92b instead of the branch electrodes 191a-193b. Each set of the branch electrodes 271a-271b are formed in a rectangular opening facing a pixel electrode 190 and their positions are substantially the same as the positions of the oblique portions of the cutouts 71-72b shown in FIGS. 2 and 3. Each of the pixel electrodes 190 has the shape of a rectangular plate that has chamfered edges disposed at positions of the branch electrodes 193a and 193b shown in FIGS. 1 and 3, and the positions of the cutouts 91-92b are substantially the same as the positions of the branch electrodes 191a-192b.

In this configuration, the electric field generated by the pixel electrodes 190 and the common electrode 270 has a reversed shape of the electric field shown in FIG. 4, and thus the arrangement of the LC molecules 31 is also reversed.

In addition, the semiconductor stripes 151 of the TFT array panel 100 according to this embodiment have almost the same planar shapes as the data lines 171 and the drain electrodes 175 as well as the underlying ohmic contacts 161 and 165. However, the semiconductor stripe projections 154 include some exposed portions, which are not covered with the data lines 171 and the drain electrodes 175, such as portions located between the source electrodes 173 and the drain electrodes 175.

A manufacturing method of the TFT array panel according to an embodiment of the present invention simultaneously forms the data lines 171, the drain electrodes 175, the semiconductors 151, and the ohmic contacts 161 and 165 using one photolithography process.

A photoresist pattern for the photolithography process has a position-dependent thickness, and in particular, it has first and second portions with decreased thickness. The first portions are located on wire areas that will be occupied by the data lines 171 and the drain electrodes 175, and the second portions are located on channel areas of TFTs.

The position-dependent thickness of the photoresist is obtained by several techniques, for example, by providing translucent areas on the exposure mask as well as transparent areas and light blocking opaque areas. The translucent areas may have a slit pattern, a lattice pattern, a thin film(s) with intermediate transmittance or intermediate thickness. When using a slit pattern, it is preferable that the width of the slits or the distance between the slits is smaller than the resolution of a light exposer used for the photolithography. Another example is to use reflowable photoresist. Once a photoresist pattern made of a reflowable material is formed by using a normal exposure mask only with transparent areas and opaque areas, it is subject to a reflow process to flow onto areas without the photoresist, thereby forming thin portions.

As a result, the manufacturing process is simplified by omitting a photolithography step.

Many of the above-described features of the LCD shown in FIGS. 1-4 may be appropriate to the TFT array panel shown in FIGS. 5 and 6.

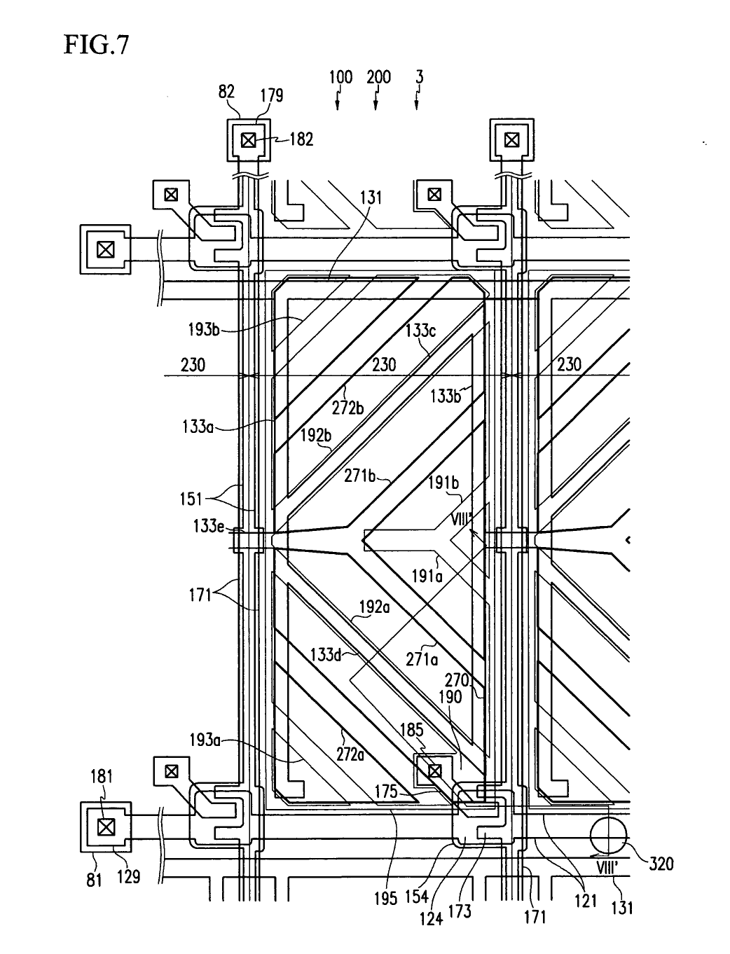

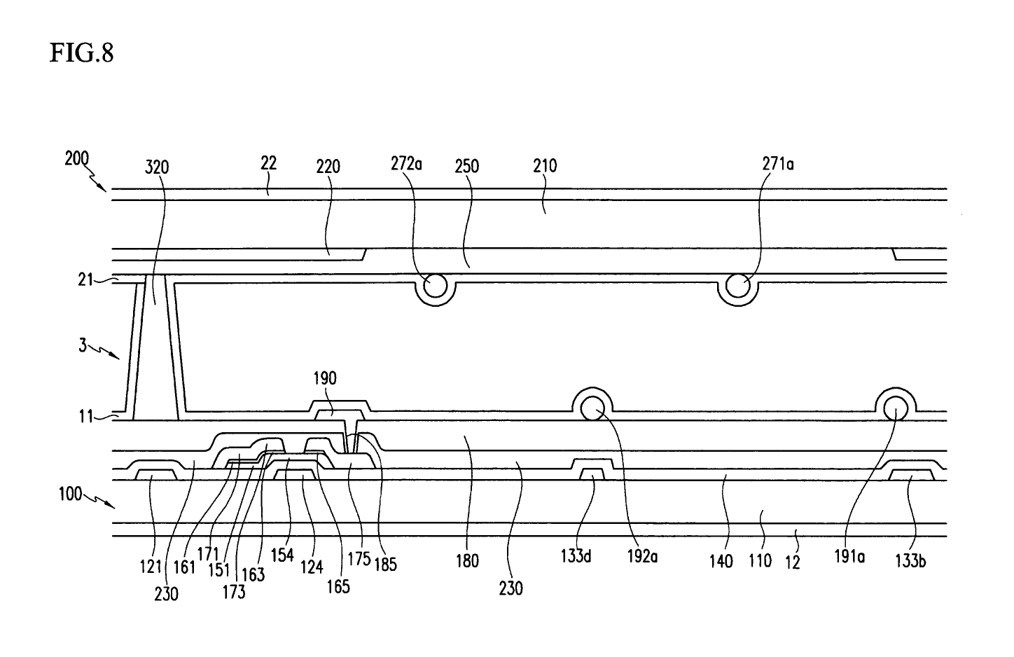

An LCD according to another embodiment of the present invention will be described in detail with reference to FIGS. 7 and 8.

FIG. 7 shows a layout view of an LCD according to another embodiment of the present invention, and FIG. 8 shows a sectional view of the LCD shown in FIG. 7 taken along the line VIII-VIII′.

Referring to FIGS. 7 and 8, an LCD according to this embodiment includes a TFT array panel 100, a common electrode panel 200, a LC layer 3 and a plurality of columnar spacers 320 interposed between the panels 100 and 200, and a pair of polarizers 12 and 22 attached on outer surfaces of the panels 100 and 200.

Layered structures of the panels 100 and 200 according to this embodiment are almost the same as those shown in FIGS. 1-4 and FIGS. 5 and 6.

Regarding the TFT array panel 100, a plurality of gate lines 121 including gate electrodes 124 and gate line end portions 129 and a plurality of storage electrode lines 131 including storage electrodes 133a-133d and storage connections 133e are formed on an insulating substrate 110. A gate insulating layer 140, a plurality of semiconductor stripes 151 including semiconductor stripe projections 154, and a plurality of ohmic contact stripes 161 including ohmic contact stripe projections 163 and a plurality of ohmic contact islands 165 are sequentially formed on the gate lines 121 and the storage electrodes lines 131. A plurality of data lines 171 including source electrodes 173 and data line end portions 179 and a plurality of drain electrodes 175 are formed on the ohmic contacts 161 and 165 and the gate insulating layer 140, and a passivation layer 180 is formed thereon. A plurality of contact holes 181, 182 and 185 are provided at the passivation layer 180 and the gate insulating layer 140. A plurality of pixel electrodes 190 and a plurality of contact assistants 81 and 82 are formed on the passivation layer 180, and a plurality of columnar spacers 320 and an alignment layer 11 are formed thereon.

Regarding the common electrode panel 200, a light blocking member 220, an overcoat 250, a common electrode 270, and an alignment layer 21 are formed on an insulating substrate 210.

Each of the pixel electrodes 190 includes a plurality of branch electrodes 191a-193b like those shown in FIGS. 1-4, and the common electrode 270 includes a plurality of sets of branch electrodes 271a-272b like those shown in FIGS. 6 and 7.

In addition, the TFT array panel 100 includes a plurality of color filters 230 disposed under the passivation layer 180, while the common electrode panel 200 has no color filter. The color filters 230 extend along a longitudinal direction and edges of an adjacent two of the color filters 230 exactly match with each other on the data lines 171, but the color filters 230 may overlap each other to block the light leakage between the pixel electrodes 190, or may be spaced apart from each other. When the color filters 230 overlap each other, the light blocking member 220 disposed on a common electrode panel 200 may be omitted.

The LCD shown in FIGS. 7 and 8 may have many of the above-described features of the LCD shown in FIGS. 1-4.

The present invention can be employed with any type of LCD such as twisted-nematic (TN) mode LCD, in-plane switching (IPS) mode LCD.

Although preferred embodiments, of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A liquid crystal display comprising:
a first signal line;
a second signal line intersecting the first signal line;
a thin film transistor connected to the first and the second signal lines;
a first field generating electrode and a second field generating electrode facing each other; and
a liquid crystal layer disposed between the first field generating electrode and the second field generating electrode,
wherein one of the first and the second field generating electrodes is connected to the thin film transistor, and the first field generating electrode includes a plurality of first branch electrodes extending obliquely to the first and the second signal lines.

2. The liquid crystal display of claim 1, wherein the first branch electrodes are connected to each other.

3. The liquid crystal display of claim 2, wherein the first field generating electrode further comprises a frame electrode connected to the first branch electrodes.

4. The liquid crystal display of claim 3, wherein the frame electrode has main edges substantially parallel to the first and the second signal lines.

5. The liquid crystal display of claim 4, wherein the first field generating electrode is connected to the thin film transistor.

6. The liquid crystal display of claim 2, wherein the first field generating electrode further comprises a main body having an opening and the first branch electrodes cross the opening.

7. The liquid crystal display of claim 6, wherein the opening has edges substantially parallel to the first and the second signal lines.

8. The liquid crystal display of claim 7, wherein the second field generating electrode is connected to the thin film transistor.

9. The liquid crystal display of claim 1, wherein the first branch electrodes have a width about 0.2 to about 4 times the thickness of the liquid crystal layer.

10. The liquid crystal display of claim 1, wherein a distance between the first branch electrodes is about 1 to about 10 times the thickness of the liquid crystal layer.

11. The liquid crystal display of claim 1, further comprising a plurality of tilt direction determining members arranged alternatively to the first branch electrodes.

12. The liquid crystal display of claim 11, wherein the tilt direction determining members comprise a plurality of cutouts disposed at the second field generating electrode.

13. The liquid crystal display of claim 11, wherein the distance between the first branch electrode and the tilt direction determining member is about 0.5 to about 5 times the thickness of the liquid crystal layer.

14. The liquid crystal display of claim 1, wherein the second field generating electrode includes a plurality of second branch electrodes arranged alternatively to the first branch electrodes.

15. The liquid crystal display of claim 1, further comprising a third signal line overlapping the first branch electrodes.

16. The liquid crystal display of claim 1, wherein the first field generating electrode comprises a portion overlapping the first signal lines or the second signal line.

17. The liquid crystal display of claim 1, wherein the first branch electrodes comprise IZO (indium zinc oxide) or ITO (indium tin oxide).

18. The liquid crystal display of claim 1, wherein the first branch electrodes comprise the same layer as the first signal line or the second signal line.

19. A liquid crystal display comprising:
a first signal line;
a second signal line intersecting the first signal line;
a thin film transistor connected to the first and the second signal lines;
a first field generating electrode and a second field generating electrode facing each other; and
a liquid crystal layer disposed between the first field generating electrode and the second field generating electrode,
wherein one of the first and the second field generating electrodes is connected to the thin film transistor, and one or both of the first and the second field generating electrodes includes a plurality of branch electrodes extending obliquely to the first and the second signal lines.

20. The liquid crystal display of claim 19, wherein one or both of the first and the second field generating electrodes further comprises a main body having a plurality of openings and the branch electrodes cross the openings.
